(19) United States
(12) Patent Application Publication
(10) Pub. No.: US 2012/0296708 A1
(43) Pub. Date: Nov. 22, 2012

(54) System and Method For Managing Payment Based Parking with Near Field Communication

(75) Inventors: Johan Bachmann, Tallinn (EE); Lawrence Berman, Delray Beach, FL (US)

(73) Assignee: NOW! Innovations, Tallinn (EE)

(21) Appl. No.: 13/474,912

(22) Filed: May 18, 2012

Related U.S. Application Data
(60) Provisional application No. 61/487,584, filed on May 18, 2011.

(51) Int. Cl. G06Q 20/16; G06Q 50/30; G06Q 20/32

(52) U.S. Cl. 705/13; 235/379

(57) ABSTRACT

A system for parking payment including a parking device with a near field communications unit and a server, where the server receives a message from a mobile device, the message including parking information received by the mobile device from the near field communications unit and identifying information for the mobile device, locates an account in a client database based on the identifying information for the mobile device, and charges the account the cost of parking for a period of time.

### CROSS-REFERENCE TO RELATED APPLICATION

This application claims priority on the basis of U.S. Provisional Patent Application No. 61/487,584, filed on May 18, 2011. The entire disclosure of the provisional patent application is incorporated herein by this reference.

### BACKGROUND

A person who wishes to park on-street or off-street in an area that has parking meters may find an open space to park and park their vehicle in that space. The person may then need to have enough quarters to pay the parking meter, and in some cases the meter may be broken. Some parking maters may allow payment by credit cards, but some types of credit cards may not be accepted by the parking meter, and others may be rejected at the parking meters for multiple reasons. To enforce parking time limits and ensure spaces are paid for, an enforcement officer may need to look at a single space meter and visibly determine if a person has paid to park. Enforcement at multi-space meters may be even more difficult. At a pay-by-space machine an officer may need to pull a receipt from the machine or use a handheld to see that spaces have been paid for. With current Pay and Display parking systems, a person purchasing a ticket from a multi-space meter must place it on the dashboard of their vehicle. This receipt is sometimes placed upside down or falls off the dash and many parkers are issued tickets due to these and similar issues. In the normal routine the officer still has to read the ticket on the dashboard and determine if it is good for the time and date posted in the receipt.

Some parking spaces can also be paid for via cell phone. Cell phone parking requires an account set up with the company that has the contract for the city, town or private operator, or the purchase of a prepaid card. The parker then calls a posted number on the meters. The parker is connected to an Integrated Voice Response System which asks them to enter their location ID followed by the amount of time they wish to park.

### BRIEF SUMMARY

It is an object of the present invention to provide a system and method for managing payment based parking with near field communication.

In accordance with an aspect of the present invention, a system for parking payment includes a parking device including a near field communications unit and a server, where the server receives a message from a mobile device, the message including parking information received by the mobile device from the near field communications unit and identifying information for the mobile device, locates an account in a client database based on the identifying information for the mobile device, and charges the account the cost of parking for a period of time.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

FIG. 1 depicts an exemplary NFC parking payment system;

FIG. 2 depicts an exemplary procedure for paying for parking with an NFC parking payment system; and

FIG. 3 depicts an exemplary NFC parking enforcement system.

### DETAILED DESCRIPTION

A near field communication (NFC) payment system for parking may create connectivity between mobile phones and physical things. The system may enable people to interact with everyday objects through their mobile phone, and may streamline paying for parking.

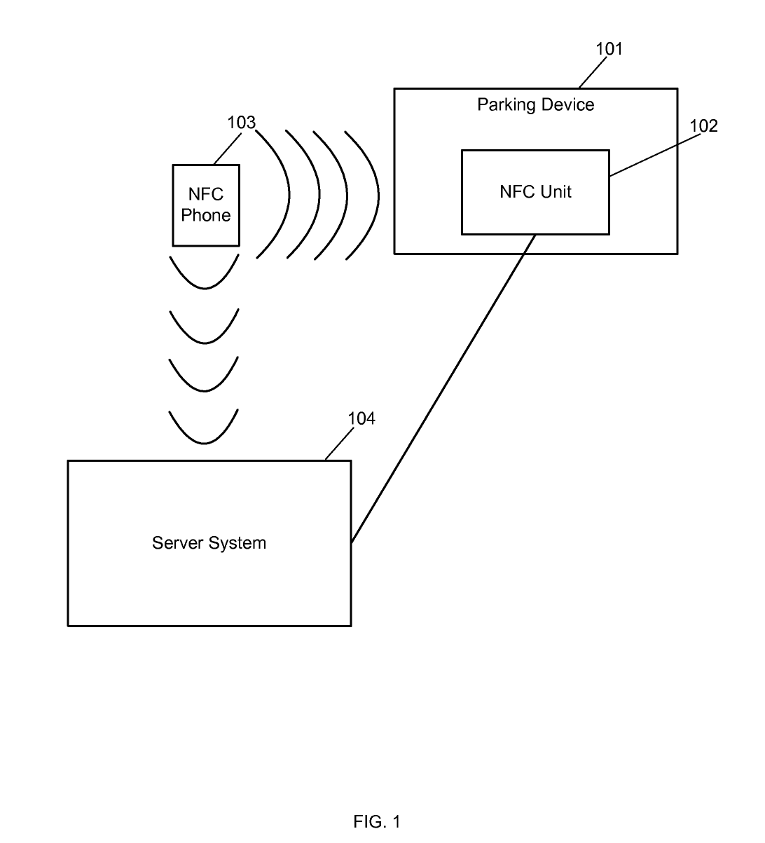

FIG. 1 depicts an exemplary NFC parking payment system. To implement an NFC parking payment system, parking tag, such as, for example, a Near Field Communications unit (NFC unit or NFC tag) 102, in the form of, for example, an NFC chip, may be attached to or inserted into a parking device 101, such as, for example, a parking meter. The NFC unit 102 may allow for short range wireless communication with other NFC equipped devices. Alternatively, or in conjunction with the NFC unit 102, a 2D barcode, or QR code, may be added to either the parking device 101 or parking space number sign to act as a parking tag. A Radio Frequency Identification (RFID) device may also be used as a parking tag in conjunction with or in place of the NFC unit 102. This may be done for parking devices 101 that cover single or multi spaces.

The NFC unit 102, which may be called Touch “N” Park, may be programmed so that when an NFC equipped mobile phone 103, or other NFC equipped mobile device, is touched to the encapsulated NFC unit 102 or decal mounted on a meter, or garage entrance equipment or a sign designating a space, the NFC unit 102 may read the programmed tag. The mobile phone 103 may then send a message to a server 104, using any suitable communications system, including, for example, wireless broadband service, cellular service, Unstructured Supplementary Service Data (USSD), SMS, or other radio bands. The server 104 may be any suitable computer or computing device. The server 104 may check in its client database for the phone number, or other suitable identifying information such as email address, Instant Messaging account ID, or custom user ID known to the server 104, that was sent with the message information from the mobile phone 103. If the user of the mobile phone 103 has an account in the client database, the maximum time permitted to park may be assigned, completing a parking transaction. An application may also open on the mobile phone 103, to allow for the entry of more detailed information. The NFC unit 102 in the parking meter may also be in communication with the server 104 through any suitable communication system, including, for example, the phone lines, wired broadband, wireless broadband, cellular service, or other radio bands. The NFC unit 102 may receive information from the server 104, such as, for example, parking payment information.

If the parking meter has a 2D bar code, the bar code may be scanned with one of many bar code scanning applications for mobile phones. This process may be called “Scan N Park”. After the 2D bar code has been scanned, the system may work similarly to the NFC system as described previously. The 2D bar codes may be placed on any suitable parking device 101, such as, for example, single space meters, multi-space meters and parking tickets of all forms. The 2D bar codes may also be placed on informational posters or any place a person must pay for parking This may include the payment for parking permits.

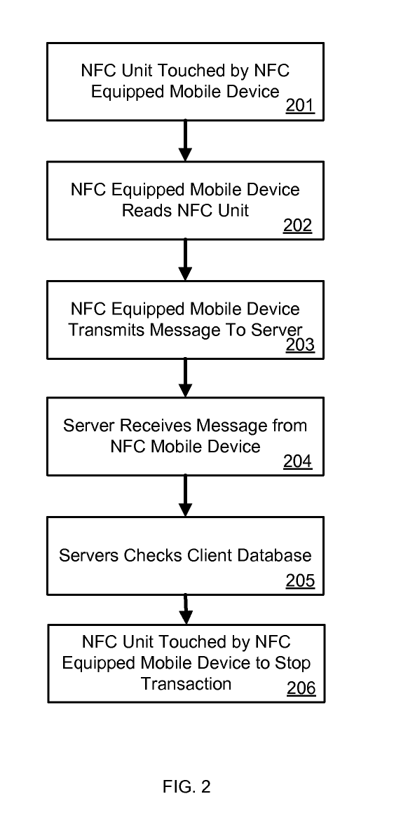

FIG. 2 depicts an exemplary procedure for paying for parking with an NFC parking payment system. In block 201, an NFC equipped mobile device may be touched to an NFC unit in a parking device. For example, after parking in a space, a person may touch the mobile phone 103 to the NFC unit 102 of the parking device 101 responsible for monitoring the space the person has parked in.

In block 202, the NFC equipped mobile device may read the NFC unit in the parking device. For example, the mobile phone 103 may read information from the NFC unit 102, such as, for example, the location of the parking device 101, the cost to park at the parking device 101, and any other information that may be relevant to paying for parking.

In block 203, the NFC equipped mobile device may transmit a message to a server. For example, the mobile phone 103 may transmit a message to the server 104, including information read from the NFC unit 102, identifying information for the mobile phone 103 such as, for example, the phone number associated with the mobile phone 103, and any other information that may relevant to paying for parking Additional information may be entered into a program running on the mobile phone 103 by a user. For example, if the parking device 101 monitors multiple spaces, the user may need to enter the space number of the space they wish to pay for into the mobile phone 103, so that the space number can be transmitted to the server 104 along with the other information in the message. Other information entered by the user may include an amount of time the user wishes to pay for and identifying information for the vehicle in the parking space.

In block 204, the server may receive the message from the NFC equipped mobile device. For example, the server 104 may receive the message transmitted by the mobile phone 103.

In block 205, the server may check in a client database for the identifying information sent in the message information from the NFC equipped mobile phone 103. For example, the server 104 may check the client database to determine if the user of the mobile phone 103 has an account in the client database, as identified by the phone number or other identifying information transmitted in the message from the mobile phone 103 to the server 104. If the user of the mobile phone 103 has an account, the server 104 may assign the maximum parking time, or may assign an amount of time requested in the message from the mobile phone 103 to the server 104. If the user of the mobile phone 103 does not have an account in the client database, the server 104 may signal a program running on the mobile phone 103 to request that the user of the mobile phone 103 enter information that can be used to establish an account.

In block 206, the NFC equipped mobile device may be touched to the NFC unit again, stopping the parking transaction. For example, when the person returns to their vehicle they may touch the NFC unit 102 again with the mobile phone 103, stopping the parking transaction and resulting in the person being charged only for the time used. Alternatively, if the person has entered an amount of time, as in block 203, the parking transaction may end when the requested amount of time runs out. In both cases, the person may receive notification, for example, via text message, in the form of a receipt, and may receive notification five minutes prior to the end of their parking session that the session is ending. When parking in a garage, parking tickets may be encoded with a 2D bar code, which may either be associated to the ticket number or may be the same as the parking ticket number.

The NFC unit 102 in the parking device 101 may also read the unique NFC identifier in the mobile phone 103, which may allow for the user to pay for parking at the parking device 101 with the use of an electronic wallet. An electronic wallet may be a payment program running on the mobile phone 103.

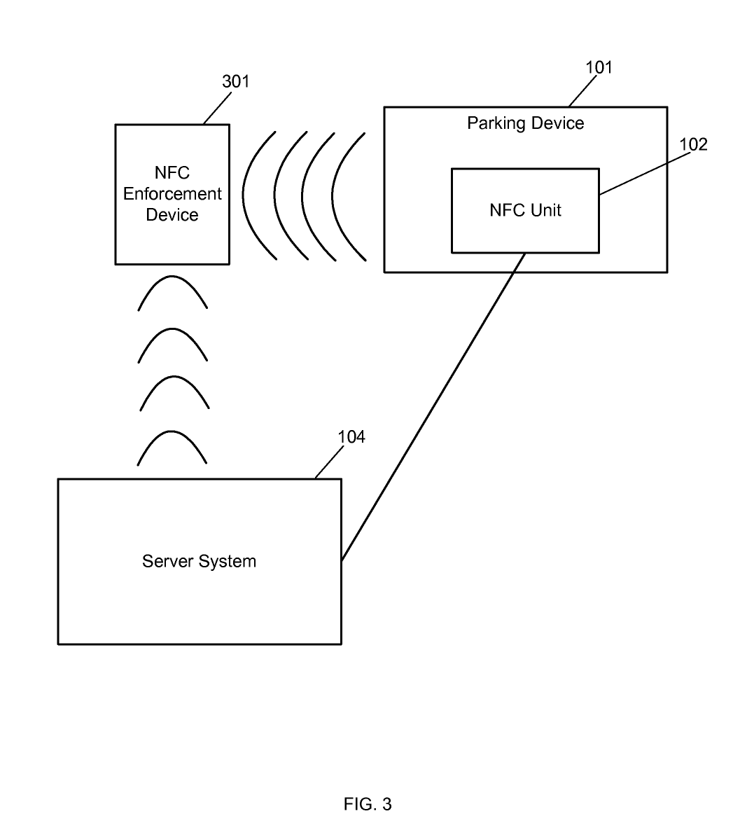

FIG. 3 depicts an exemplary NFC parking enforcement system. The NFC parking payment system may allow for enforcement of parking sessions to be done using the NFC unit 102 in the parking device 101. With the use of the NFC unit 102, an enforcement officer may touch the NFC unit 102, which may be mounted to a space number sign, to determine if the space has been paid for. NFC enforcement may enable an enforcement officer to have all paid transactions transmitted live to an NFC enforcement device 301, which may be a handheld or cell phone running a special enforcement application, where the transactions can be viewed. The transactions may be stored locally, for example, at the parking device 101, or remotely at a server, such as the server 104. Any vehicle which did not pay may not be on the list of paid vehicles in the enforcement application, and any vehicle whose time has elapsed may be removed from the list in real time. GPS may be used to find the zone the enforcement office is currently in, or the enforcement officer may touch an NFC unit 102 on the parking device 101 on the block face being enforced, to ensure the proper list of vehicles and transactions is sent to the enforcement application.

Vehicles may also be equipped with an NFC unit, such as the NFC unit 102. With NFC enforcement and a windshield decal with an embedded NFC unit 102, it may be possible to enforce paid parking transactions by touching the decal.

When touching the decal on a vehicle with the NFC enforcement device 301, all paid current transactions for that vehicle may appear on the NFC enforcement device 301. This may include, but is not limited to, for example, residential parking permits, single space meters, multi space meters or any permit issued to that vehicle for any event or parking transaction. The decal may be, for example, a Touch“N”Park decal.

When using a 2D barcode system in place of, or in addition to, an NFC parking payment system, a parking ticket issued by a ticket machine when entering a garage may be scanned upon leaving the garage with any suitable device, such as, for example the mobile phone 103 running a program for scanning 2D bar codes. The scanning of the ticket may cause the mobile phone 103 to communicate with a server, such as the server 104, for the 2D parking system. The server 104 may verify that the mobile phone 103 being used has an account on the server, as with the NFC parking payment system. If the account has enough funds the transaction may be completed and sent to a parking garage server to indicate that the ticket number has been paid. The parker then only has to insert their ticket into the machine at the gate. The gate may open and they may exit the facility.

Using either NFC or 2D barcodes may also allow for payment to be made at recharging stations for electric vehicles.

The NFC and 2D barcode systems may also be used for maintenance and collections, which may be done by scanning the same NFC units 102 as used for parking payments or enforcement. An electronic device may scan the QR Code or NFC unit 102 on the parking device 101, and may report any maintenance condition to a server, or just indicate that the parking device 101 is fine and time stamp when the meter was checked. Parking meter revenue may be collected in a similar manner.

The NFC and 2D barcode systems may also permit the interfacing of a cell phone parking payment with an In-Car meter (ICM). The ICM may be a device which has a screen that shows a parking officer that a payment has been made and may shows the remaining time left in the parking transaction. A server, such as the server 104, may send information to the ICM to post on its screen. If the device has malfunctioned or is being checked for authenticity a QR Code on the unit may be scanned.

A vehicle sensor may send a signal to the server 104 indicating that the vehicle is present in a particular parking space. The server 104 may interact with a private sector or government server, which may communicate with the parking device to put time on that device with the aid of depositing coins or any other payment method at the parking device. All meters that have no time on them may still be scanned thru NFC or QR codes to double check for payment.

The parking device 101 or parking garage may use a QR code or the NFC unit 102 that would enable a parker or user of alternative applications to scan the QR code or NFC unit 102 and be forwarded to a web site where they can register for an account with the provider of the payment application.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wire line varieties thereof, and/or any other computerized device capable of configuration for receiving, storing and/or processing data for standalone application and/or over a networked medium or media. Examples of communication media that can be employed include, without limitation, wireless data networks, wire line networks, and/or a variety of networked media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer-readable media.

In general, computer-readable media may include any medium capable of being a carrier for an electronic signal representative of data stored, communicated or processed in accordance with embodiments of the present invention. Where applicable, method steps described herein may be embodied or executed as instructions stored on a computer-readable medium or media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions.

Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the following claims.

What is claimed is:

1. A system for parking payment comprising:
a parking device comprising a near field communications unit; and
a server;
wherein the server is configured to:
receive a message from a mobile device, the message comprising parking information received by the mobile device from the near field communications unit and identifying information for the mobile device;
locate an account in a client database based on the identifying information for the mobile device; and
charge the account the cost of parking for a period of time.

2. The system of claim 1, wherein the mobile device is a mobile phone.

3. The system of claim 1, wherein the mobile device is an In-Car Meter.

4. The system of claim 1, wherein the parking device is one of a parking meter, a sidewalk pay station, a parking garage pay station, and a physical object to which the near field communications unit is attached.

5. The system of claim 1, wherein the server is further configured to receive an amount of parking time input into the mobile device.

6. The system of claim 1, wherein the server is configured to receive the message from the mobile device transmitted using one of: an SMS message, an automated telephone call, cellular data, Wi-Fi, and Unstructured Supplementary Service Data.

7. The system of claim 1, wherein the identifying information for the mobile device is one of: a phone number, an email address, a custom user ID, and an Instant Messaging account ID.

8. A system for parking payment comprising:
a parking device comprising parking tag; and
a server;
wherein the server is configured to:
receive a message from a mobile device, the message comprising parking information determined by the mobile device from the parking tag and identifying information for the mobile device;
locate an account in a client database based on the identifying information for the mobile device; and
charge the account the cost of parking for a period of time.

9. The system of claim 8, wherein the parking tag is a 2-D bar code.

10. The system of claim 8, wherein the parking tag is an RFID device.

11. The system of claim 8, wherein the parking device is one of a parking meter, a sidewalk pay station, a parking garage pay station, and a physical object to which the parking tag is attached.

12. The system of claim 8, wherein the server is configured to receive the message from the mobile device transmitted using one of: an SMS message, an automated telephone call, cellular data, Wi-Fi, and Unstructured Supplementary Service Data.

13. The system of claim 8, wherein the identifying information for the mobile device is one of: a phone number, an email address, a custom user ID, and an Instant Messaging account ID.

15. A method of receiving payment for parking comprising:
receiving a communication from a mobile device comprising identifying information for the mobile device and parking device information;
checking an account database to determine if the identifying information corresponds to an account;
crediting parking time at a parking location related to the parking device to the account; and
receiving payment from the account.

16. The method of claim 15, wherein the mobile device receives the parking device information through near field communications.

17. The method of claim 15, wherein the mobile device receives the parking device information through scanning a 2-D barcode.

18. The method of claim 15, wherein the communication from the mobile device further comprises a desired amount of parking time, and wherein crediting parking time at the parking location further comprises crediting the desired amount of parking time.

19. The method of claim 15, further comprising:
transmitting to the mobile device a request for information; and
receiving the information from the mobile device.

19. The method of claim 15, further comprising:
transmitting to the parking device the parking time credited to the account.

20. A system for parking enforcement comprising:
a parking device comprising a near field communications unit;
a handheld device compatible with the near field communications unit; and
a parking system server in communication with the handheld device,
wherein the handheld device is configured to communicate with the near field communications unit to determine the location of the handheld device, send the location to the parking system server, and receive from the parking system server a list of paid transactions related to the location of the handheld device.

21. A system for parking system maintenance comprising:
a parking device comprising a near field communications unit;
a handheld device compatible with the near field communications unit; and
a parking system server in communication with the handheld device, wherein the handheld device is configured to communicate with the near field communications unit to determine a maintenance status of the parking device, and send the maintenance status of the parking device to the parking system server.
